(19) United States
(12) Patent Application Publication
(10) Pub. No.: US 2013/0110671 A1
(43) Pub. Date: May 2, 2013

(54) METHODS AND SYSTEMS FOR ONLINE SHOPPING INCORPORATING DASHBOARD FEATURES

(71) Applicant: Beau Gray, Menomonee Falls, WI (US)

(72) Inventor: Beau Gray, Menomonee Falls, WI (US)

(21) Appl. No.: 13/529,748

(22) Filed: Jun. 21, 2012

Related U.S. Application Data
(60) Provisional application No. 61/499,974, filed on Jun. 22, 2011.

(51) Int. Cl. G06Q 30/06

(52) U.S. Cl. CPC G06Q 30/0643
USPC 705/26.8; 705/27.2

(57) ABSTRACT

Methods, systems, apparatuses, and media are directed to processing information, including apparel information. A dashboard widget is provided, wherein the dashboard widget comprises a plurality of modes of managing shopping items. At least one of the plurality of modes is activated, wherein the modes are configured to manage at least one of the shopping items. Thee processing of at least one of the shopping items is managed. Notification is provided related to at least one of the items as it relates to at least one of the plurality of modes. Based on the notification, the moving the shopping items between the plurality of modes is managed.

### CROSS-REFERENCE TO RELATED APPLICATIONS

This application claims the benefit of provisional application 61/499,974 filed Jun. 22, 2011, and the entire content of that application is expressly incorporated herein by reference thereto.

### FIELD OF THE INVENTION

This invention generally relates to online shopping, and more particularly, but not exclusively, to features for enhancing the user experience.

### BACKGROUND

Online shopping systems often enable a shopper to search for items, place the items in a cart, and/or purchase the items. In a typical online shopping system, the cart is displayed on the top panel of the webpage as an accessible tab. However, the user may not be able to visualize the items in the cart while continuing shopping, and therefore unable to compare or match the already selected items with the new items being browsed. Although the cart may exist for a short period of time, e.g., over a few sessions of shopping, the user usually may not aware of the inventory difference between different sessions when a new session starts and end up wasting time proceed to check out items no longer available in the inventory. It is with respect to these issues and others that the present invention is directed.

In addition, online shopping interfaces and features currently known to be offered are often times kludgy, difficult to interact with, cumbersome, or inefficient. For example, they typically may not provide qualities sometimes found useful in shopping for goods in person. These deficiencies can reduce the stickiness of a site, which works against the intended business purpose of driving sales and consumer loyalty. Also for example, known shopping sites may not take the approach of establishing features to extend the length of time a user stays in the site to shop.

Other problems have to do with providing features within the confines of interacting through a computer graphical interface. Developing new tools for user interaction and shopping that are for example clever in their ease of use or in their interaction to enhance the shopping experience would be of value. It is with respect to these and other concerns that the embodiments of the present invention are directed.

### SUMMARY

In accordance with principles of the invention, computer-implemented methods, systems, apparatus, and media for shopping and managing shopping are provided. In one embodiment, a method is directed to managing an apparel over a network. In general, the method includes providing, a navigation of an electronic commerce source while simultaneously providing a dashboard widget representative of apparel data; wherein the dashboard widget may include at least one mode for managing the apparel in the dashboard widget, and wherein the dashboard widget is an overlay (e.g., superimposed) over the content that remains graphically accessible when the user scrolls around. In one embodiment, the dashboard retains state information about the apparel in the at least one mode persistently between sessions of usage of the dashboard widget. In one embodiment, the dashboard is displayed in an overlay (e.g., superimposed) over the content of an application (e.g., web browser, shopping program, web page, information website, etc.), wherein the dashboard remains accessible (e.g., remains graphically accessible) when the user scrolls around the application (e.g., displaying different portions (view ports) of the applications' view). In one embodiment, the user is provided an option to reposition the dashboard. In one embodiment of the method, managing the apparel may include at least one of: enabling purchasing of the apparel, sharing the apparel, arranging the apparel in a virtual closet, or adding the apparel to a wish list wherein the apparel so added is not purchased.

In another embodiment, the method further may include displaying the dashboard widget using the persistently stored state information in a session (a) at substantially similar place on the user's display between each session and (b) within a boundary (including a constrained boundary) on the display to permit usage of the remainder of the display without distraction from the dashboard widget.

In one embodiment of the method, the apparel data is received from at least one of: selection by the user, shared from a friend of the user, or suggested by an application in communication with the electronic commerce source.

In one embodiment, the method further may include providing an activation component within the dashboard widget to configure a panel for providing a selectable catalog of items available in the inventory of the electronic commerce source that are configured to be added into the apparel data; and in response to adding an item, providing a visual indication of the item on the dashboard widget. The apparel data selected by the user is stored in the dashboard widget after the user finishes one session of the navigation, and can be viewed in subsequent shopping sessions.

In one embodiment, a cookie is used to recognize the user. At the beginning of each session, the state of the electronic commerce source is checked and a notification regarding the state of each item in the dashboard widget will be provided. If the inventory check reveals that one or more item is no longer available or one or more item is no longer available in the quantity selected by the user, an error message or other forms of visual indication will be displayed in association with said one or more item.

The method also includes providing an activation component within the dashboard widget to activate one of the at least one mode for displaying the apparels in the dashboard widget, wherein the at least one mode for displaying the apparels in the dashboard widget may include a wish list mode, a virtual closet mode and a purchasing mode.

In one preferred embodiment, the method further may include providing one or more qualification component within the dashboard widget for moving an item between the at least one mode to another mode.

The method further may include providing a status component within the dashboard widget for configuring the dashboard widget to one of the closed state, the condensed state, and the expanded state, with the closed state displays the least amount of information and the expanded state showing the maximum amount of information regarding the items in the dashboard. In one embodiment, in the expanded, the dashboard widget may cover all or substantially all of the display, window, or application to which the dashboard is attached or otherwise associated. state The condensed state of the dashboard widget is capable of displaying in a space (e.g., a space that is constrained, defined, pre-defined, defined based on user interactions and/or content of an application, or the like) mostly everything that is accomplished by a traditional full page view. The method may also include receiving a drag-and-drop of the item from a plurality of portions of the electronic commerce source. The method may also include embedding the dashboard widget within each webpage of the electronic commerce source for displaying at an attached area of the screen, for example at the bottom of the user's display screen. In one embodiment, the dashboard is attached in an area on the user's display and/or an application. In another embodiment, the dashboard can be moved around by the user to different areas of the user's display.

Embodiments of a method of the invention may further comprise receiving a drag-and-drop of items, including apparel data, from a plurality of portions of the electronic commerce source.

In some embodiments, the invention also provides a system for shopping for apparel over a network. The system may include a dashboard widget for displaying apparel data, which may include a plurality of modes for displaying the apparels in the dashboard widget; and a dashboard widget manager configured to perform actions comprising providing an activation component within the dashboard widget to configure a panel for providing a selectable catalog of items available in the inventory of an electronic commerce source that are configured to be added into the apparel data; and in response to adding an item, providing a visual indication of the item on the dashboard widget; wherein the item may then be moved to one of the plurality of modes for displaying the apparels in the dashboard widget. The dashboard widget manager of the system is also configured to perform actions further comprising providing, over the network, a navigation of the electronic commerce source while simultaneously providing, over the network, the dashboard widget for displaying apparel data at a place on the user's browser. The apparel data is stored in the dashboard widget after the user finishes a shopping session. The dashboard widget manager of the system is also configured to perform actions further comprising checking the inventory of the electronic commerce source at the beginning of each shopping session and providing a visual indication regarding the inventory information of each item in the dashboard widget.

In one embodiment, the electronic commerce source may include a webpage comprising a dashboard located in a persistent or attached area of the webpage, wherein the dashboard has at least one tabs for activating each of the plurality of modes for managing the apparels in the dashboard. In one embodiment, the dashboard is located at the bottom of the webpage. The dashboard can be in at least one of three different states, i.e., the closed state, the condensed state, and the expanded state. The condensed state of the dashboard widget is capable of displaying mostly everything that is accomplished by a traditional full page view. When in the closed state, the dashboard displays the least amount of information. The expanded state of the dashboard shows the maximum amount of information regarding the items in the dashboard.

The webpage can include a catalog mode wherein a region displayed where a user can browse catalog items and select to take different actions with respect to the catalog items including adding the item to the dashboard. The dashboard may include a plurality of modes for displaying the apparels in the dashboard. In one embodiment, the plurality of modes for displaying the apparels in the dashboard may include a wish list mode and a purchasing mode. The wish list mode is a region where a user can put items that the user would like to have but choose not to purchase at that time. In one embodiment, the wish list mode is available to others through a social network so that others can select one or more items from the wish list mode to purchase for the user. The purchasing mode is similar to a traditional shopping cart, wherein a user can add items to the purchase mode that the shopper has decided to purchase at checkout.

In some embodiments, a processor readable medium for managing information over a network can be provided. The processor readable medium may include instructions that when executed by a processor cause the processor to perform actions comprising: (1) providing an interface for managing a user's dashboard widget displaying the apparel data, wherein the dashboard widget may include at least one mode for displaying the apparels in the dashboard widget; and (2) checking the inventory of the electronic commerce source at the beginning of each shopping session and providing a visual indication regarding the inventory information of each item in the dashboard widget. The actions may further comprise receiving an item from a plurality of portions of the electronic commerce source, and in response to adding an item, providing a visual indication of the item on the dashboard widget. The actions performed by the processor may further comprise providing at least one qualification component within the dashboard widget to move an item between the wish list mode and the purchasing mode. The actions may further comprise providing an access of wish list mode to a friend of the user through a social network.

Another embodiment relates to an apparatus for improving shopping for apparels over a network that includes a processor for performing actions. The actions can include providing, to a user, a interface for managing a user's dashboard widget displaying the apparel data selected by a user, wherein the dashboard widget may include at least one mode for displaying the apparels in the dashboard widget; and (2) checking the inventory of the electronic commerce source at the beginning of each shopping session and providing a visual indication regarding the inventory information of each item in the dashboard widget. The actions may further comprise receiving an item from a plurality of portions of the electronic commerce source, and in response to adding an item, providing a visual indication of the item on the dashboard widget.

In one embodiment, the invention relates to the method of performing the actions of the apparatus. In another embodiment the invention relates to a method for an online retailer of garments and accessories to provide for shopping and purchasing of online catalog items via online platform. The method can include implementing a website for shoppers to access to view and purchase catalog items; providing a shopper with the opportunity to have four modes of interaction with the website, and providing a community tool that presents one or more options to a current shopper and transmits a message comprising a link corresponding to a particular apparel selected by the current shopper wherein the link pulls social contacts of a shopper into the website to view that particular apparel in the wish list mode.

The website can include a catalog mode wherein a region displayed where a user can browse catalog items and select to take different actions with respect to the items including adding an item to a wish list mode where a user can put items that the user would like to have but choose not to purchase at that time; and to a purchasing mode wherein a user can add items that the shopper has decided to purchase at checkout.

In one embodiment, the community tool is implemented to store relationships between shoppers on the website. In one embodiment, the website provides access to information that is otherwise blocked based on relationship information of a current shopper to other shoppers on the website. In one embodiment, the wish list mode provides access to other shoppers who are in the current shopper's circle can access to the wish list mode.

Another embodiment relates to a system for an online retailer of garments and accessories to provide for shopping and purchasing of online catalog items via an online platform. The system can include one or more computers and software implemented on the computers configured to provide a website for shoppers to access to view and purchase catalog items; providing a shopper with the opportunity to have four modes of interaction with the website, and providing a community tool that presents one or more options to a current shopper and transmits a message comprising a link corresponding to a particular apparel selected by the current shopper wherein the link pulls social contacts of a shopper into the website to view that particular apparel in the wish list mode.

The website can include a catalog mode wherein a region displayed where a user can browse catalog items and select to take different actions with respect to the items including adding an item to a wish list mode where a user can put items that the user would like to have but choose not to purchase at that time; and to a purchasing mode wherein a user can add items that the shopper has decided to purchase at checkout.

In one embodiment, the community tool is implemented to store relationships between shoppers on the website. In one embodiment, the website provides access to information that is otherwise blocked based on relationship information of a current shopper to other shoppers on the website. In one embodiment, the wish list mode provides access to other shoppers who are in the current shopper's circle.

Embodiments of the invention also include a method for processing information. In one embodiment, the method may include (1) providing a dashboard widget, wherein the dashboard widget may include a plurality of modes of managing shopping items; (2) activating at least one of the plurality of modes, wherein the modes are configured to manage at least one of the shopping items; and (3) managing processing of at least one of the shopping items. In a preferred embodiment, the method of the invention further may include providing notification related to at least one of the items as it relates to at least one of the plurality of modes; and based on the notification, managing moving the shopping items between the plurality of modes.

In one embodiment, the methods, systems and media described herein may be configured with other components, instructions or steps, including performing additional actions comprising providing an animation to indicate a change of state for at least one of site entry, locating a store, opening a container, configuring options for the apparel or widget, locating an item, adding an item, closing the container to show transition from a logical state to another logical state. In one embodiment, the animation can include fading, sliding, expansion, contraction or morphing.

### BRIEF DESCRIPTION OF THE DRAWINGS

The nature and various advantages of present inventive systems, methods, or media will become more apparent upon consideration of the following detailed description, taken in conjunction with the accompanying drawings, in which like reference characters refer to like parts throughout, and in which:

FIG. 1 shows the closed state of the dashboard in accordance with one or more embodiments of the invention;

FIG. 2 shows the closed state of the bag in accordance with one or more embodiments of the invention;

FIG. 3 shows an example of the Item Edit Modal in accordance with one or more embodiments of the invention;

FIGS. 4A and 4B show an example of Enter discount code modal window without success text (4A) and with success text (4B) in accordance with one or more embodiments of the invention;

FIG. 4C shows the expanded state of the bag in accordance with one or more embodiments of the invention;

FIG. 5 shows an example of a system for managing information (e.g., apparel data) in accordance with one or more embodiments of the invention;

FIG. 6 shows a logical flow diagram for a process for managing information (e.g., apparel data) in accordance with one or more embodiments of the invention; and

FIG. 7 shows a logical flow diagram for a process for managing information (e.g., apparel data), including using animation to show changes of state of apparel related mechanisms and data.

### DETAILED DESCRIPTION

Features and tools to advance the user shopping experience are described below. As used herein, the term “apparel” may include clothing and accessories. In one embodiment, “item” refers to items purchasable or operable by the processes and system disclosed herein, including apparel items. In one embodiment of the invention, apparel may include one or more items as part of an out and/or the method, systems, apparatus, and/or media described herein may be adapted to managed outfit and/or outfit data. As used herein, the term “widget” refers to an embedded user interface that may be placed within another user interface unless the context indicates otherwise or further clarifies. As used herein, the term “fixed” means fixed or semi-fixed to an area and/or attached to a substantially similar area between sessions. As used herein, the term “animation” or “animate” refers to computer based graphical processes for showing change of states, including changes in the state of logical entities managed by the system and method, such as the shopping bag, and/or the state of mechanisms such as the dashboard, and/or states representing changes of both logical entities and mechanisms. In one embodiment, animation can include fading, sliding, expansion, contraction, morphing, or the like. The change of state, can for example, be illustratively demonstrated by the action of one or more of animation operations such as fading, sliding, expansion, contraction, or morphing. The term “linked” refers to logical relationships stored in computer readable data and associated with computer based processes for recording, enforcing, confirming, or otherwise operating on the linkage between the data. While the description below discloses operations on a “bag” or “wish list”, the operations are interchangeable and/or applicable to other types of container, such as a share bag, sharable with friends, an recommendation bag for recommending items, or the like.

For example, a user may be provided with a dashboard that provides a place where a user can hold items of interest while shopping. Advantageously, the dashboard persists in a attached area on the user's display so that a user can view the contents of the dashboard without leaving the shopping mode. This feature is especially valuable when the user is in full screen experiences, such as holiday gift guides. The dashboard can be an integrated part of that experience. This allows the user to have consistent confirmations of the items they have selected throughout the site, as well as the ability to manage the selected items from anywhere on the site.

In a preferred embodiment, the dashboard is persistently associated to the bottom of the user's display and/or application and/or application's visible viewport. In one embodiment, the dashboard appears in a plurality of pages on the website. In one embodiment, the dashboard may exclude displaying during the checkout process (e.g., on the check display/pages). In one embodiment, when the user uses an iPad or other type of tablet or mobile device or a display in full screen mode, the dashboard will be associated with the bottom of the page, screen, application, or display, as the case may be. In one embodiment, unlike toolbars for application, the dashboard is contextually displayed based on the content of the page (e..g, display the dashboard when on pages presenting apparel items, but may not display when on pages presenting checkout). Any testing criteria may be used to determine when to display the dashboard.

The dashboard may include a plurality of modes for displaying apparel data, depending on the interest of the user in any specific item. In a preferred embodiment, the dashboard encompasses two different modes, i.e., the wish list mode and the purchasing mode (the bag). The dashboard widget allows the user to manage an apparel over a network by enabling purchasing of the apparel, sharing the apparel, arranging the apparel in a virtual closet, or adding the apparel to a wish list wherein the apparel so added is not purchased. The dashboard utilizes one of the three different states, i.e., the closed state, the condensed state and the open/expanded state.

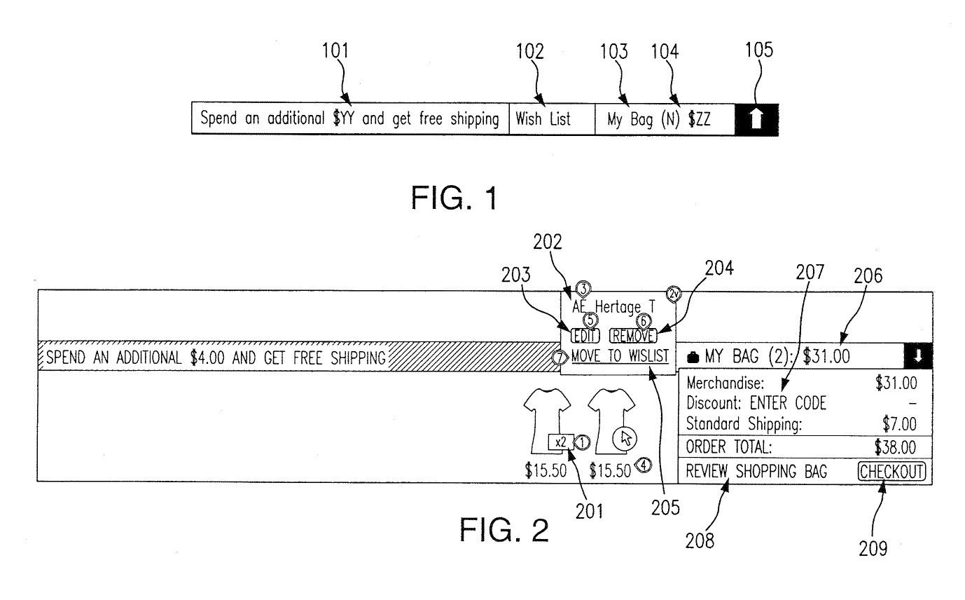

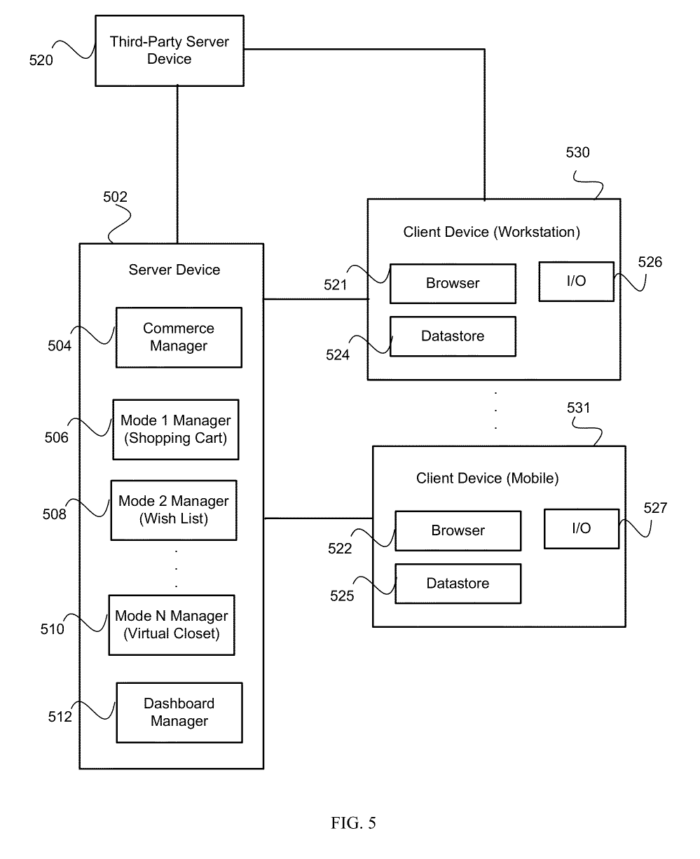

FIG. 1-3, 4A-4C show examples of the dashboard in accordance with one or more embodiments of the invention. The components shown may be provided in any user interface, including a web interface, a mobile interface, or the like. The dimensions, colors, layout and configurations shown are examples, and other such attributes may be varied without departing from the scope of the invention. The components shown may be displayed or otherwise provided on a device, such as devices 408, 520, 530-531 of FIG. 5.

### 1. The Closed State of the Dashboard

When entering the website for the first time, the bag animates open and then closes again after three seconds. As shown in FIG. 1, in the closed state, the dash board provides the least amount of information, but also takes up the least amount of space.

In particular, the dashboard shows the free shipping calculator 101 which dynamically updates to show how far the user is from the free shipping threshold. Initially, the message reads, “Free standard shipping when you spend $XX or more” where “$XX” is the free shipping threshold. Once the user adds items to the bag, the message changes to, “Spend an additional $YY and get free shipping.” Finally, once free shipping is obtained, the message can read, “You've qualified to receive free standard shipping!” As international customers, or other designated customers are may not be eligible to receive free shipping, once the website recognizes that the user is international, the free shipping calculator 101 would not be displayed.

The dash board in the closed state also shows the Wish List tab 102 and the My Bag tab 103, clicking on each of which opens the dashboard to the condensed wish list state and the condensed bag state, respectively.

The dash board in the closed state further shows bag total 104, which keeps a running total of the items currently in the bag. However, in one embodiment, this bag total does not include tax.

The dash board in the closed state further may include an arrow button 105, which opens the dashboard to the condensed bag state. In a preferred embodiment, users can open the condensed bag state by clicking anywhere on the dashboard, other than the Wish List tab 102. For example, the user can click on the My Bag tab 103, the arrow button 105, or anywhere else on the dashboard to open the bag to the condensed view. If the user clicks on the Wish List tab 102, then the dashboard opens to the Wish List view.

In a preferred embodiment, the user can also open the bag to the next state by clicking on the “My Bag” link in the top bar of the website. For example, if the bag is in the closed state, clicking on the “My Bag” link will open the bag to the condensed state, and if it is in the condensed state, then clicking on the “My Bag” link will open to the bag to the expanded state. Thus, the “My Bag” link helps the user transition to using the dashboard. This link will be grayed out and disabled during checkout.

In a preferred embodiment, the optimal size of the dashboard is 1010px wide. However, when the user's browser is not set to accommodate the 1010px optimal width, the dashboard is able to shrink or expand to a minimum width no larger than 600px wide. When shrinking, the space between the tabs and the free shipping calculator, as well as the number of products visible per page, can be the first to fall off. This feature allows the proper display of the dashboard, which is a part of the online shopping experience.

### 2. The Condensed State of the Bag

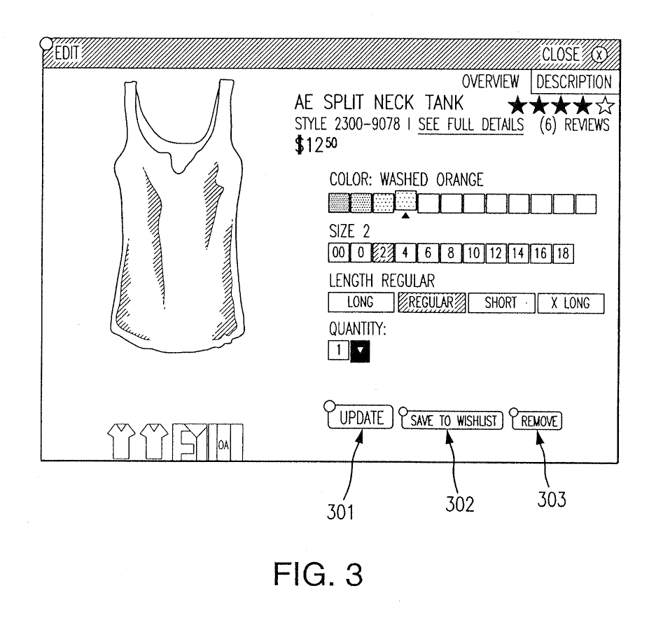

As shown in FIG. 2, the condensed state of the bag displays mostly everything (or substantial portions thereof) that is accomplished by a traditional full page view. This state provides additional details such as specific items collected by the user, prices, item editing and movement controls.

The condensed bag state may include an Item Quantity Indicator 201, which updates to indicate the number of items the product image represents. The Item Quantity Indicator 201 only displays with quantities greater than one.

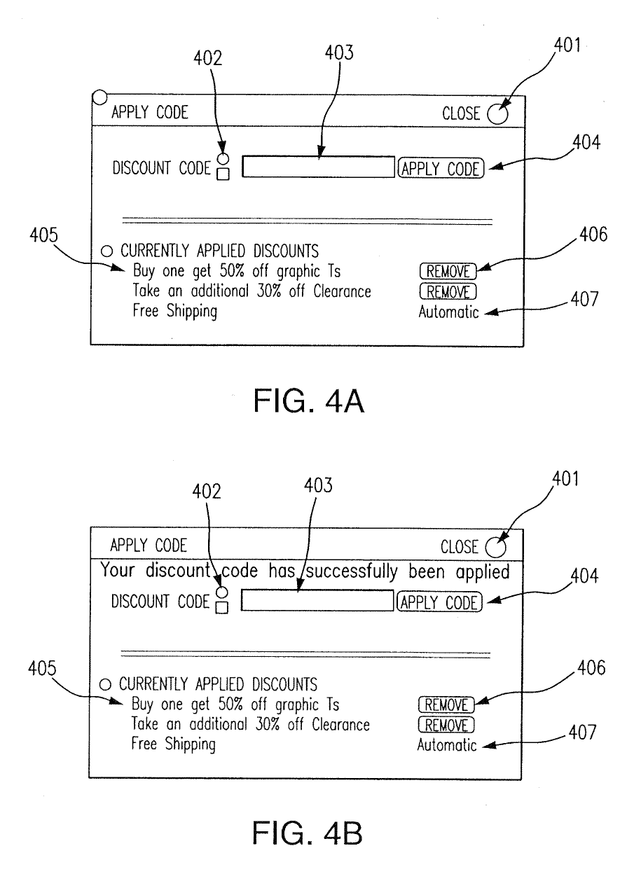

The condensed bag state also may include an Item Context Menu 202, which appears when the user rolls the mouse over an item in the bag, and gives additional product information and several options to perform on the item. The additional information includes product name and price. If the product name doesn't fit on one line, it would span two lines. The price shown is the total price after discount of the item(s) represented by the product image. The options to perform on the item are represented by the Edit tab 203; the Remove tab 204; and the Move to Wish List Link 205. The Edit tab 203 opens the Item Edit Modal (see FIG. 3) for editing the features of the selected item such as color, size, length and quantity, or saving the item to the Wish List. The Remove tab 204 removes the product from the bag while the Move to Wish List Link 205 pops up a Wish List modal window prompting the user to select list details as part of the necessary item qualification.

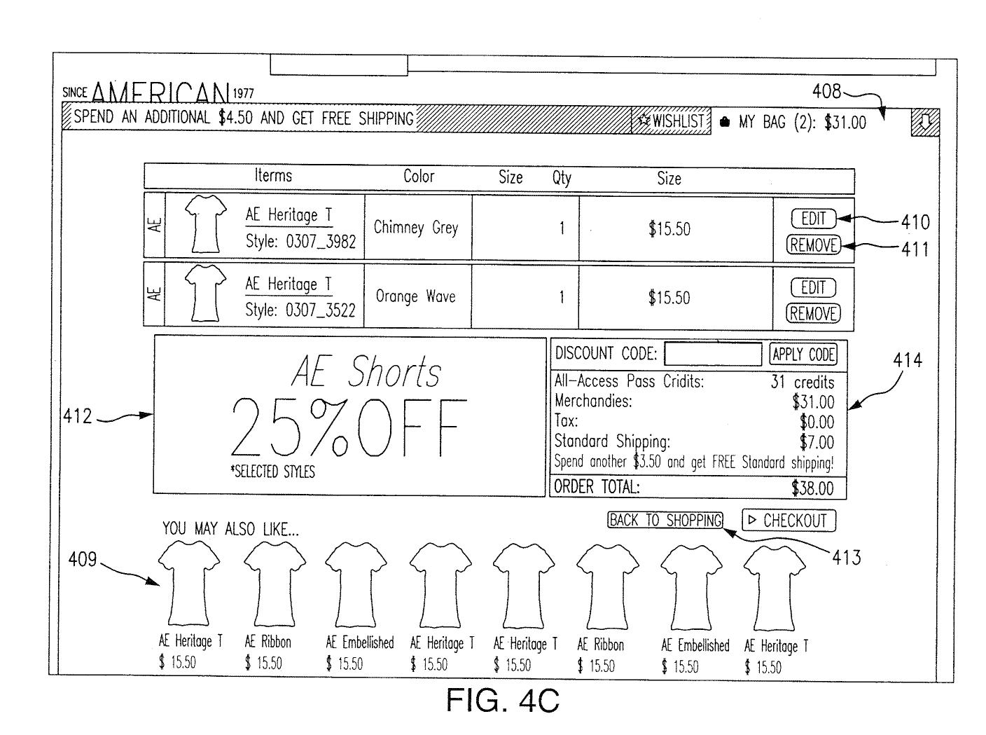

The condensed bag state also may include an Order Total Calculator 206, which is an area of the bag that gives additional dynamic information on pricing and promotions of everything (or substantial portions thereof) in the bag. The Order Total Calculator 206 has an Enter Code button 207 which launches a discount modal window (see FIGS. 4A and 4B) prompting the user to enter a discount code; a Review Shopping Bag Link 208 which animates open the bag to the expanded state; and a Checkout button 209 which initiates the checkout process by either launching a sign in/continue as guest modal window, or proceeding directly to the checkout process if the user is already signed in. The dashboard is not present within the checkout process. The Order Total Calculator 206 also displays the total price of the merchandise before discounts and shipping; the discount as a line item that dynamically appears or disappears if a discount is applied or removed, respectively; the shipping price which shows the standard US shipping price by default and the order total which is an estimate of what the user will pay after discounts and shipping, but before tax. If the shipping type is changed during checkout, the shipping price will be updated to reflect the chosen shipping cost and method. The discount can either be code based by entering an 8 or 20 digit code into the Discount Code field, or auto-applied with a text label indicating that the promotion was automatically applied, and cannot be removed. Means of applying discount are well known in the art and have been disclosed, e.g., in US patent application publication no. 2010/0094729, the entire content of which is hereby incorporated by reference thereto.

When there is nothing in the bag, the condensed state of the bag will display an empty bag message that varies depending on whether the user is signed in and whether there is any items in the save-for-later, which contains items remain in the dashboard when the user leaves shopping. For example, when the user is signed in and there are items in saved-for-later, the message will be “You don't have any items in your bag. Move items from saved for later to your bag.” When the user is signed in and there are no items in saved-for-later, the message will be “You don't have any items in your bag.” When the user is not signed in and there are items in saved-for-later, the message will be “You don't have any items in your bag. Sign in to see any saved items or move items from saved for later into your bag.” When the user is not signed in and there are no items in saved-for-later, the message will be “You don't have any items in your bag. Sign in to see any saved items.”

Once the bag fills up with more items than can fit in a single screen, left and right directional arrows will appear to control pagination. When pressed, each will cycle though four products at a time in a circular fashion until the end of the list is reached. When the end of the list is reached, the arrow should be masked or hidden since it is no longer clickable.

The Item Edit Modal window can be opened by clicking the Edit tab 203 in the condensed bag state. As shown in FIG. 3, the Item Edit Modal is similar to a quick view window, but is used to update an item already in the bag rather than add a new one. The Update tab 301 updates the changes made to the color, size and other properties of the item and closes the modal window. The Save To Wish List tab 302 adds the item to the Wish List while the Remove tab 303 permanently removes the item from the bag without confirmation.

The Discount Modal window can be opened by clicking the Enter Code button 207 in the condensed bag state. As shown in FIGS. 4A and 4B, this modal window provides an easy way to add discounts without having to go to the expanded bag view or checkout. Users have to manually close this modal window by clicking the Close button 401. To help the user, there is a Discount Code Question Mark 402 next to the Discount Code field 403. When the Discount Code Question Mark 402 is clicked, a tooltip opens which reads: “Applying Discounts—Enter your 8 or 20 digit code into the Discount Code field without any spaces, then click the Apply Discount button. Learn More about how to find and apply discounts.” The Apply Code button 404 validates and applies the code, and adds it to the Currently Applied Discounts table 405. As soon as the code has been successfully applied, the Discount Code field 403 should be cleared of the entered code, and a message should appear above the Discount Code field 403 stating, “Your discount has successfully been applied.” This update should happen real-time. The Currently Applied Discounts table 405 lists code-based and auto-apply promotions that can applied to the current order. Auto-apply promotions are automatically added and removed as needed by clicking the Remove button 406, which removes the code-based promotion from the order. The Automatic tag 407 is a text label that indicates that the promotion was automatically applied, and cannot be removed.

Inventory is checked when the user first arrives at the site with a new session, in addition to the routine inventory checks in the bag and during checkout. Although inventory doesn't need to be checked every page, out of stock items should persist between pages within the session. When the inventory check reviews that an item is no longer available or an item is not available in the quantity requested by the user, a visual indication of error is displayed. For example, an item with an error can be shown as having reduced transparency, as well as a red border with a triangular exclamation mark in the upper right corner. When the user's mouse is rolled over the item with an error, an error tooltip displaying an error message will appear to provide details of the specific error such as “The item is no longer available” or “Insufficient quantity error”. When the item is no longer available, the error tool tip will also contain a Remove Now button to allow the user to remove the product immediately from the bag, instead of waiting for the item to be automatically removed during checkout. When the user has an item with a higher quantity than is currently available, the error tool tip will contain an Update Now button to allow the user to update the quantity of the item to match the quantity available. If the user doesn't do this manually, the quantity will automatically update.

### 3. The Expanded Bag State

Referring to FIG. 4C, the user enters an expanded state view by clicking on the appropriate view button from the My Bag tab or the Wish List tab. For example, to get into the expanded bag state, the user would click the “Review Shopping Bag” link in condensed bag state. The expanded state overlays the current page being viewed, so that the user can always close the expanded state to return to where they left off. In one embodiment, the My Bag view may provide user interface components which may enable a user shop and/or browse for apparel and/or shop from one or more stores.

The Close/Arrow button 408 causes the bag to transition via animation from the expanded bag state into the condensed bag state. The Cross Sells 409 shows a horizontal listing of eight products, keyed off of the last product added to the bag. Clicking on any one of the products opens a quick view window for viewing the details of the selected product. The Edit button 410 launches the same product edit quick view that is used during the checkout process. The Remove button 411 removes the item from the bag and replaces the product with a message, which contains an Undo button that allows the remove action to be undone. The Promotional Content 412 displays any single promotion that needs bag visibility. The Back to Shopping button 413 is functionally equivalent to the Close/Arrow button 408 and transitions the bag via animation from the expanded state into the condensed state. The Expanded Order Total Calculator 414 works the same as it does during checkout.

In one preferred embodiment, a notification system is applied to show the user confirmation actions taken on a particular product. The notification consists of a tooltip-like container anchored to the appropriate tab on the dashboard, depending on where the item is being moved. When an item is moved or added to the bag or the wish list, the bag tooltip notification appears as soon as the action is taken and remains for a duration of three seconds after the bag fully loads. If the bag was closed, then it can open (to the appropriate tab) for the duration of the tooltip plus one second, and then close again. Items in the bag are loaded right to left.

In a preferred embodiment, the user is able to quickly add, move, or remove items in a row without the page reloading. If the user performs multiple add or move actions within the two second confirmation, then the quantity indicator increments accordingly and the two second timer window is reset.

When the user arrives to the site for the first time in a shopping session, the dashboard can animate open from its closed state, stay open for three seconds, and then close again. This process helps the user to understand the new location of the bag, and shows the user confirmation actions taken on a particular product.

In a preferred embodiment, the website contains local store choice as one of the head elements, which allows the user to set a local store, and have easy access to both that local store, as well as finding a new store. The head elements also include the “My Bag” link which can open the dashboard to the expanded state. This design would help customers who are used to the location of the current bag find the dashboard.

More In one embodiment, the navigation structure of the website has a vertical scheme, instead of a horizontal-only scheme. The website includes standard navigation element such as a gender category which may include links that aren't associated with gender such as clearance; featured categories section which contains shops, guides, new arrivals, or any other section that doesn't belong under the standard category sections; top level categories which are the highest expandable categories under a particular gender and contain several related subcategories; second level categories and third level categories which further break down product to a more specific level; and third level categories. When these categories are active, a bullet is placed next to the label. These categories are directly related to page filtering.

Since clearance includes items across categories and genders, the clearance section will always have one more category level than a standard section. For example, if the user goes into clearance, the gender still needs to be selected before any sub-category can be chosen. This means that categories that are normally top level become second level, second level becomes third level, and third level becomes fourth level. Since selecting a gender category is an important first step in clearance shopping, making sure these are easily accessible and visible is a high priority. In order to do this, landing on the clearance homepage can have its subcategories hidden by default if there are more than two gender categories. Clicking on the appropriate gender category will then both expose the sub-categories and navigate to the category section page.

Like clearance, footwear & accessories includes items across categories and genders, and will always have one more category level than a standard section. Since selecting a gender category is also an important first step in footwear & accessories shopping, landing on the footwear & accessories homepage can have its sub-categories hidden by default if there are more than two gender categories.

In a preferred embodiment, the website has powerful filters to let the user easily customize the product they look at, in terms of styles, colors, sizes and price sorting, thus giving a new powerful tool to the user. The user can select multiple options by clicking multiple filter options. Selected filter options can likewise be unselected by clicking on them. If the user unselects options, the filter is identified as clear. Selecting two options within a filter category can display results that match criteria for either option. Thus, selecting more options within a filter category tends to yield a larger set of product results. For example, if the user selects “New Arrivals” and “Web Exclusives”, results can include products that are either a New Arrival or Web Exclusive, or another state determined by the system. When filtering across multiple filter menus, products must match criteria selected in each filter category to be displayed. Thus, selecting options from more than one filter category tends to reduce the number of product results. For example, if the user has made selections in both the “Style” and “Color” filter categories, then products must match at least one selected option in the “Style” filter and one selected option in the “Color” filter. To try and avoid displaying an empty product set, only filter options that will not yield an empty product set can be active. Options that would yield an empty product set can be inactive. Filters can be opened by clicking on the title bar of the filter. The filter closes again when the user clicks on the title bar of the filter. Filters can also be closed by clicking anywhere outside the filter. A filter category with no options selected is treated as if at least some or all items are selected. Filtering may be delayed until at least one option within the filtering category is selected. Otherwise, if any filtering category had nothing selected, there could be no possible product results, as no products could match the filtering criteria. If the user selects options within a filter menu, and later deselects some or all options, it is considered clear, and treated as if options were selected.

Some categories may benefit from having unique filter widgets. For certain product categories, it may be useful to extend or replace the filter bar, or even omit it. For example, when there are long-term promotions, it might be useful to design an interactive banner to sit above the filter toolbar to advertise and elaborate on those kinds of promotions. Selecting such a promotion from the interactive banner could filter product based on that promotion. Also, for a product that has its own unique set of attributes, it might be useful to create a separate filter experience.

In one embodiment, the website employs a cross brand widget designed to provide bran-based cross sells of related products directly on section pages. The cross-brand widget may be In one embodiment located at the bottom of the section page, simulating the last row of products. The brand logo can be easily identifiable, and the look and feel of the widget can be brand-specific. Clicking on any of the item thumbnails will launch a quickview of that item. From the quickview, the user is able to view the full product details, which would go to the product detail page in the appropriate brand. In another embodiment, the breadcrumb provides the navigation structure of where in the catalogue the cross-brand product is located. The user can click on a link in the breadcrumb to navigate directly to that brand's indicated section.

Products that fit into multiple product categories may be displayed multiple times throughout a section page, at the discretion of the merchants. For example, a particular sweater vest might appear both in the sweaters category and the vest category. The tops section page would include both categories, and thus display the same item twice. To avoid displaying redundant product categories, merchants can be able to specify product sets that are not displayed in a top-level section page or use different ways to organize products within the category.

In another embodiment, the website also includes section pages that allow users to see a broad overview of products in a particular category before diving into a more detailed view. The product detail page provides the most in-depth information used to inform and support a user's decision to buy a product. To make this page more user friendly, In one embodiment a full browser window view with larger images are used.

An apparel bundle page is similar to a product detail page, except that it is designed to show multiple products at the same time. Bundle pages are particularly useful in the following situations:

a) Shop by Apparel

Seasonal shops such as “looks of the season” often present entire apparels to the user. The apparel bundle pages presents the user components of the apparel, and add the ones that he or she likes to the bag.

b) Women's Swimwear

Women's swimwear often includes both a top and a bottom piece that the user is able to purchase separately or together. Using the apparel bundle page provides a good mechanism in which to do this.

c) Aerie Perfect Pairs

Aerie often likes to show matching bras and undies either through a shop experience or through section pages. Much like women's swimwear, the apparel bundle page is also a good way to show these pairs.

There are two main ways in which to show bundles, i.e., as a quickview bundle or on a full page. The method that can be used varies depending on the situation. Note that every time an apparel is displayed on the website, it can be linked to either an apparel or quickview bundle page.

The quickview bundle can be used wherever an apparel is presented, but it is not desirable to link to a full detail page. Examples include category lifestyle images, homepage images and shops. If there are more than five items in the apparel, then scroll arrows become active. Clicking on an arrow scrolls through the product one at a time by selecting the next product thumbnail in the indicated direction. If the next product thumbnail is hidden, then the entire set of product thumbnails scroll to show the newly visible thumbnail. When there are no additional products to display in a direction, the appropriate scroll arrow becomes disabled.

The currently selected item in the apparel includes a dark boarder to indicate that it is selected. The details of the selected product are what appears in the quickview window. Clicking on a product thumbnail selects that product, and shows the details in the quickview window. Lifestyle images on the site can be linked to a bundle. To create more affordance around this functionality, a “get this look” button is shown on rollover of appropriate lifestyle images. Clicking anywhere on the lifestyle image can open the quick view bundle. Just like a product detail page, the quickview bundles can include a zoom feature when clicking on the product image. When adding items from a quickview bundle, the modal will not close like a regular quickview to encourage users to continue shopping the bundle. Since there will be an overlay covering up the dashboard animation, the quickview modal will show the same notification from the dashboard to inform the user that they've added the item.

The Apparel bundle pages can be thought of as a product detail page, and can be used in situations where a product detail page is best suited. Apparels that are displayed on standard section pages can always link to an apparel bundle page, while apparels elsewhere on the site have the option to link to the apparel bundle page or the quickview bundle page. Apparel bundle pages In one embodiment include an image of a model wearing the entire apparel to allow users to see both how the products will fit, and how the different items look together when worn together. If there is no onbody image, then the bundle page will look similar to a regular product page but with the additional top product selector. Just like the quickview bundle, the product selector is used to switch between different items in the apparel. When one of the items is clicked, the reset of the page immediately updates to reflect the change. This includes the product configuration area as well as the corresponding tabs below the product, such as customer reviews. Just like a product detail page, the apparel bundles can include a zoom feature when clicking on the product image.

Users become frustrated when they see something they like on an apparel, but it doesn't show up in the bundle. Rather than having items fall off the bundle page when they're not available, items in an apparel can be represented. If the item is not available for purchase, it can be listed as out of stock or coming soon. When bundle items are out of stock, the first available item is shown upon coming to the bundle page. If none are available, the first item will be shown with selections disabled, and with a message indicating that the item is not currently available. The displayed message could be “N/A” or some other message/effect that indicates why the item isn't available. When an item is completely out of stock, none of the sizes are able to be selected; and both the quantity indicator and the add to bag button can be disabled. When an item is out of stock online, a message in red will appear to serve as an indicator. This message may vary depending on the availability status of the item. The user can also have the option to check the inventory at their local store, if applicable.

In one embodiment of the invention, the search function of the website is enhanced by the inclusion of an incremental (live) search component, a better structured results page, and a universal, unified search that indexes pages throughout the site including help sections, store results, and wish lists. In particular, the search results header lists the total number of results across tabs, and the user's search query in quotation marks. The results panel contains a list of filterable product in the same format as a standard category page for product results. A results link shows the number of results it contains next to its category name, and is only visible if it contains one or more results. This number is the current amount of results on the viewable page. When users click to show more results, these numbers will update. The Number of Results by Gender link shows the number of results it contains next to its gender, and is only visible if it contains one or more results. The number of results displayed in the link doesn't change when product is filtered. The filters can act the same as they do on category pages. Selection tabs can always be in the same order. The tab that is selected when the user enters the page is based on the gender tab in which the user was browsing. If not on a gender tab (homepage, account management, etc.) then, the system can default to the tab with the most relevant results. The user's search query may be configured to not clear from the search box on the results page. In one embodiment, the page can display 100 results before showing a “Show More Results” button. When clicking this button, the user will get up to an additional 100 results. Numbers might not be exactly 100 when results include products with multiple color options. in the event that no results are found from the search, a page will be presented with brand widgets such as the cross brand widget and “Check out these instead”.

### Illustrative System

FIG. 5 shows an example of a system for managing an apparel. Components of FIG. 5 may be hardware or software components, including computing devices, integrated circuits, or the like. Components of FIG. 5 may be separate devices communicating with each other over a network (including a wireless network). At least some of the components may be within the same device and may communicate with each other over a bus, direct connection, or the like.

As shown, client devices 530-531 are in communication with server device 502. Third-party server device 520 is in communication with server device 502 and/or client device 530.

Server device 502 includes commerce manager 504, mode 1 manager 506, mode 2 manager 508, mode N manager 510, an dashboard manager 512. Commerce manager 504 includes any component for browsing, managing, or purchasing items, including retail items such as clothes or accessories.

Mode 1 manager 506, mode 2 manager 508, and mode N manager 510 include any component for managing the processing of the information, including apparel data, including inserting, remove, modifying, sharing, or otherwise operating on the information. In one embodiment, mode 2 manager 506 may provide functionality for managing a shopping cart, checking out the shopping items in the shopping cart, purchasing the items, receiving shipping information, or the like. In one embodiment, the check out component may use the online payment system as disclosed in U.S. patent application Ser. No. 12/904,601, which is incorporated herein by reference in its entirety. In one embodiment, the different mode components perform different operations on information of the same or similar type (e.g., apparel data). In one embodiment, mode 2 manager 508 may provide functionality for managing a wish list, including reminder the user of items in the wish list, expiring items from the wish list, providing incentives to purchase items and/or move items from one mode to another (e.g., offering coupons, reviews, etc. about the item), or the like. In one embodiment, mode N manager 510 may provide functionality for managing a virtual closet, such as the virtual closet disclosed at U.S. patent application Ser. No. 12/575,299, which is incorporated herein by reference in its entirety.

Apparel creator manager 508 includes any component for managing an apparel. Apparel creator manager 508 may be in communication with other the components of server device 502 to enable managing the apparel. In one embodiment, apparel creator manager 508 may perform the process of FIG. 3.

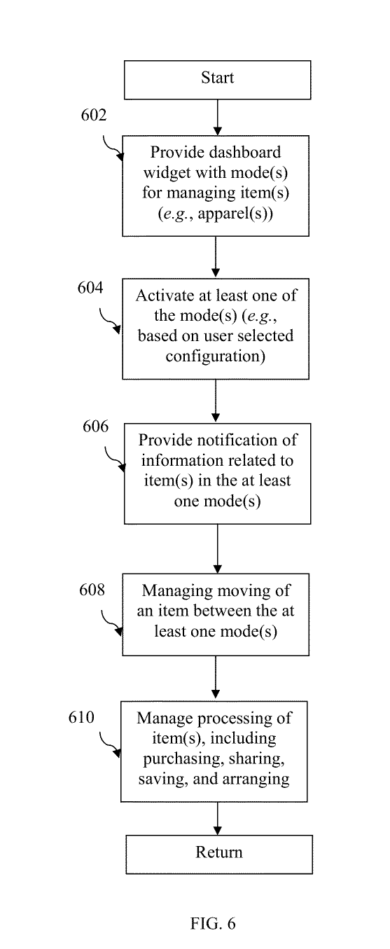

Dashboard manager 512 includes components for providing an interaction with an apparel, including an apparel to be managed by a plurality of modes. In one embodiment, dashboard manager 512 may provide a web-based component for managing the apparels. The dashboard may be provided within a webpage provided by server device 502 and/or other devices, including third-party server device 520. In one embodiment, dashboard manager 512 may perform the process of FIG. 6.

Third-party server device 520 includes any component for providing information over a network, including a server device, a mobile device, or the like. Third-party server device 520 may include a web server, a social networking server, or the like. Third-party server device 520 may provide social networking, content, or communication services, including blogs, news, emails, or the like. In one embodiment, third-party server device 520 may provide an apparel creator/virtual closet component adjacent to, in close proximity to, and/or collocated with the provided services.

Client devices 530-531 may be any computing device, including workstations, servers, mobile devices, or the like. Client devices 530 includes browsers 521-522, datastores 524-525 and input/output (I/O) components 526-527. Browsers 521-522 include any component for providing media and interaction over a network. In one embodiment, browsers 521-522 may provide the interfaces of FIGS. 1-3, 4A-4C and/or the processes of FIGS. 1-3, 4A-4C, and 6. In one embodiment, browsers 521-522 include a web browser, a mobile device browser, a text browser, or the like. Browser 521-522 communicates with server device and/or third-party server device 520 to receive and provide browsing of at least one HTML, XML, or other markup language page. In one embodiment, browser 521 provides a cross-domain enabled webpage. Cross-domain widgets or other components of the webpage may load at least some components embedded within the webpage from third-party server device 520 and server device 502. In one embodiment, a social networking component and information may be loaded from third-party server device 520 and a virtual closet and apparel creator component may be loaded from server device 502. The social networking component may provide sharing of an apparel, item, or closet between members of the social network managed by the social networking component. The cross-domain components may be enabled by, for example, cross-domain proxies, cross-domain JavaScript Object Notation (JSON). Datastore 524-525 may store apparel information. The apparel information may be uploaded through browsers 521 or 522 and provided to server device for associating with or included with apparel data. In one embodiment, the apparel data may be stored within digital closet datastore 506. I/O components 526-527 include any component for controlling browser 521-522 and/or providing information, such as a mouse, keyboard, touch screen, or the like. In one embodiment, I/O components 526-527 may enable dragging-and-dropping of an item into an apparel.

Components of the devices of FIG. 5 may comprise or be in communication with a processor readable medium for performing the operations of the invention. For example, commerce manager 504, mode N manager 510, an dashboard manager 512 and/or dashboard manager 512 may comprise or be in communication with a disk drive, RAM, ROM, or other processor readable medium for managing an apparel. The medium may comprise instructions. The instructions, when executed by a processor, may cause the processor to perform actions of FIGS. 1-3, 4A-4C, and 6. In one embodiment, the system and/or method disclosed herein may be implemented with web software such as sever and/or client side code (e.g., scripts, objects, components). In one embodiment, such system and methods may be implemented via Java, Javascript, ActiveX components, or the like.

### Illustrative Processes

FIG. 6 shows a logical flow diagram for a process for managing information (e.g., apparel data). The process of FIG. 6 may be implemented by the components of FIGS. 1-3, 4A-4C, and 5 and/or be combined with the processes of FIGS. 1-3, 4A-4C and/or 7.

The process starts at step 602, where a dashboard widget with mode(s) for managing item(s) (e.g., apparel(s)) is provided. In one embodiment, a navigation of an electronic commerce source is provided, over the network, while simultaneously providing, over the network, a dashboard widget representative of apparel data; wherein the dashboard widget may include at least one mode for managing the apparel in the dashboard widget, and wherein the dashboard widget retains state information about the apparel in the at least one mode persistently between sessions of usage of the dashboard widget. In one embodiment, the dashboard widget is for displaying apparel data and may include a plurality of modes for displaying the apparels in the dashboard widget. In one embodiment, an interface for managing a user's dashboard widget is provided for displaying the apparel data, wherein the dashboard widget may include at least one mode for displaying the apparels in the dashboard widget. In one embodiment, a dashboard widget is provided, wherein the dashboard widget may include a plurality of modes of managing shopping items.

At step 604, at least one of the mode(s) (e.g., based on user selected configuration) is activated. In one embodiment, an activation component is provided within the dashboard widget to configure a panel for providing a selectable catalog of items available in the inventory of the electronic commerce source that are configured to be added into the apparel data. In one embodiment, an activation component is provided within the dashboard widget to activate one of the at least one mode for displaying the apparel in the dashboard widget, wherein the at least one mode for displaying the apparel in the dashboard widget may include a wish list mode, a virtual closet mode, and a purchasing mode. In one embodiment, an activation component within the dashboard widget is provided to configure a panel for providing a selectable catalog of items available in the inventory of an electronic commerce source that are configured to be added into the apparel data. In one embodiment, a dashboard is located in a persistent and/or attached area of the webpage, wherein the dashboard has at least one tabs for activating each of the plurality of modes for managing the apparels in the dashboard. In one embodiment, at least one of the plurality of modes is activated, wherein the modes are configured to manage at least one of the shopping items. In one embodiment, the dashboard is displayed in an overlay (e.g., superimposed) over the content of an application (e.g., web browser), wherein the dashboard remains accessible (e.g., remains graphically accessible) when the user scrolls around the application. In one embodiment, the user is provided an option to reposition the dashboard.

At step 606, notification of information related to item(s) in the at least one mode(s) is provided. In one embodiment, and in response to adding an item, a visual indication of the item is provided on the dashboard widget. In one embodiment, in response to adding an item, a visual indication is provided of the item on the dashboard widget; wherein the item may then be moved to one of the plurality of modes for displaying the apparels in the dashboard widget. In one embodiment, the state of the electronic commerce source is checked at the beginning of each session and providing a notification regarding the state of each item in the dashboard widget. In one embodiment, a notification is provided related to at least one of the items as it relates to at least one of the plurality of modes.

At step 608, moving of an item between the at least one mode(s) is managed. In one embodiment, the item may then be moved to one of the plurality of modes for displaying the apparels in the dashboard widget. In one embodiment, based on the notification, the process (e.g., using the components of the system and/or apparatus disclosed) manages moving the shopping items between the plurality of modes.

At step 610, processing of item(s) is managed. In one embodiment, the processing may comprise at least one of purchasing, sharing, saving, or arranging apparels. In one embodiment, managing the apparel may comprise at least one of: enabling purchasing of the apparel, sharing the apparel, arranging the apparel in a virtual closet, or adding the apparel to a wish list wherein the apparel so added is not purchased

Processing then continues to other processing, including the steps of FIGS. 1-3, 4A-4C and/or 7.

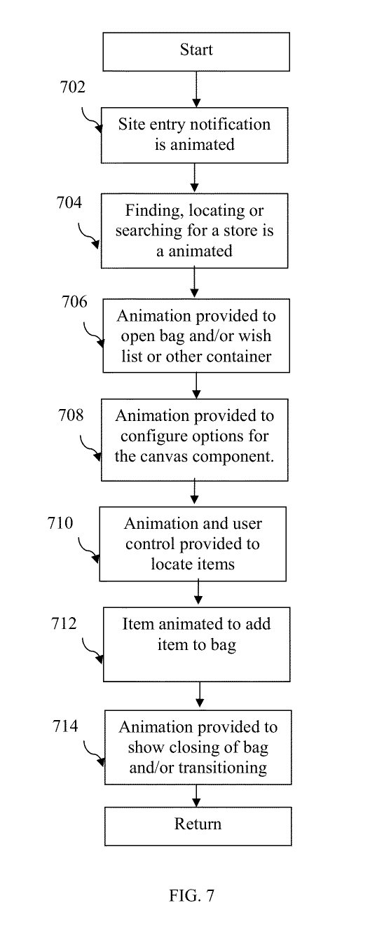

FIG. 7 shows a logical flow diagram for a process for managing information (e.g., apparel data), including using animation to show changes of state of apparel related mechanisms and data. The process of FIG. 7 may be implemented by the components of FIGS. 1-3, 4A-4C, and 5 and/or be combined with the processes of FIGS. 1-3, 4A-4C and/or 6.

At step 702, site entry notification is animated to show entry of a user onto the website. In one embodiment, when the user arrives to the site (e.g., by logging on or navigating onto a webpage associated with the site or a home page of the site), then the bag bar can animate open (e.g., slide open) from its closed state, stay open for three seconds, and then close again. The animation may be an overlay. In one embodiment, the site arrival may be for the first time arrival in a session, thus minimizing the animation displayed to the user. The animation may be configured to help the user to understand the new location of the bag, remind the user of the contents of the bag, or the like.

At step 704, the mechanism and process for finding, locating or searching for a store is a animated. In one embodiment, a user is enabled to click a link, which when clicked is configured to animate open and show the form field for a zip code entry. If the user clicks the field again, the field will animate and hide the form field. The user can enter a zip code and/or other criteria, and receive as search results stores associated with the site, portion of the site, and/or the criteria.

At step 706, a bag and/or wish list or other container is animated into an open state to show details about the container and/or items included in the container. While the closed state of a container provides the less information, the container in that state takes up less screen space. In one embodiment, the user can perform a user interaction such as clicking, or double-clicking to open the container. For example, the user can click on “Review Shopping Bag”. The container then animates open to the expanded state. An example of animation may be a sliding or opening action.

At step 708, a canvas component are animated to configure options for the canvas component. In one embodiment, the canvas component includes a bag and/or items. In one embodiment, a list of the items is displayed on the canvas, where each item can be configured. The widget may also display controls to add the canvas products/items to the bag or a wish list. A bag or wish list add can be confirmed by showing an animation of the product(s) entering the bag or wish list, including the appropriate tab representing the bag or wish list.

At step 710, animation and user control is provided to enable locating items available for processing (e.g., purchase or saving in a wish list). In one embodiment, a user can slide a items bar (vertical or horizontal bar of displayed items), to show previous or next items. In one embodiment, the user is enabled to load the previous item, e.g., in a product category. In one embodiment, the next item displayed in this state can corresponds to what the user has filtered down to on the section page, and not necessarily the original set. Transition animation can appear to graphically show the current item sliding off screen to the right, and the previous item slides on to the screen from the left, for example. In one embodiment, the user is enabled to load the next item, e.g., in the product category. In one embodiment, the next item displayed in this state can corresponds to what the user has filtered down to on the section page, and not necessarily the original set. Transition animation can appear to graphically show the current item sliding off screen to the right, and the previous item slides on to the screen from the left.

At step 712, an item such as an apparel item is animated to add the item to a bag. In one embodiment, a user is enabled to add items (e.g., by drag and drop, selection or the like) to a bag. In one embodiment, a user can add from a quickview bundle. The modal for the quickview bundle may be configured not to close like a regular quickview (described herein) to encourage users to continue shopping the bundle. In one embodiment, there may be an overlay covering up the bag bar animation. The quickview modal can show a notification (e.g., via animation from the bag bar) to inform the user that they have added the item.

At step 714, animation is provided to show closing of the bag and/or transitioning of processing to other steps. In one embodiment, the canvas component includes a bag and/or item. In one embodiment, a user may be enabled to click on a “Back to Shopping” button. In one embodiment, this button may provide functionally equivalent processing to the “Close” button. Transition animation is displayed to show the bag animating from the expanded state into the condensed state. In one embodiment, a user may be enabled to click on a “Close” button. Clicking on the button can cause the bag to transition via animation from the expanded bag state into the condensed bag state. Processing then continues to other processing, including the steps of FIGS. 1-3, 4A-4C and/or 6.

The embodiments are described herein illustratively and are not meant to limit the scope of the invention as claimed. Variations of the foregoing embodiments will be evident to a person of ordinary skill and are intended by the inventor to be encompassed by the following claims.

What is claimed is:

1. A method for managing for an apparel over a network comprising:
providing, over the network, a navigation of an electronic commerce source while simultaneously providing, a dashboard widget representative of apparel data; wherein the dashboard widget comprises at least one mode for managing the apparel in the dashboard widget, and wherein the dashboard widget retains state information about the apparel in the at least one mode persistently between sessions of usage of the dashboard widget; and
displaying the dashboard widget in an overlay over content of an application, wherein the dashboard remains accessible when a user scrolls around the application.

2. The method of claim 1, wherein managing the apparel comprises at least one of: enabling purchasing of the apparel, sharing the apparel, arranging the apparel in a virtual closet, or adding the apparel to a wish list wherein the apparel so added is not purchased.

3. The method of claim 1, wherein displaying further comprises:
displaying the dashboard widget using the persistently stored state information in a session (a) at substantially similar place on the user's display between each session and (b) within a boundary on the display to permit usage of the remainder of the display without distraction from the dashboard widget.

4. The method of claim 1, wherein the apparel data is received from at least one of: selection by the user, shared from a friend of the user, or suggested by an application in communication with the electronic commerce source.

5. The method of claim 1, further comprises
providing an activation component within the dashboard widget to configure a panel for providing a selectable catalog of items available in the inventory of the electronic commerce source that are configured to be added into the apparel data; and
in response to adding an item, providing a visual indication of the item on the dashboard widget;
wherein the apparel data is stored in the dashboard widget after the user finishes the present session.

6. The method of claim 1, further comprising checking the state of the electronic commerce source at the beginning of each session and providing a notification regarding the state of each item in the dashboard widget.

7. The method of claim 1, further comprises
providing an activation component within the dashboard widget to activate one of the at least one mode for displaying the apparel in the dashboard widget, wherein the at least one mode for displaying the apparel in the dashboard widget comprises a wish list mode, a virtual closet mode, and a purchasing mode.

8. The method of claim 7, further comprising
providing one or more qualification component within the dashboard widget for moving an item between the at least one mode to another mode.

9. The method of claim 1, further comprising:
providing a status component within the dashboard widget for configuring the dashboard widget to one of the closed state, the condensed state, and the expanded state, wherein the closed state displays the least amount of information regarding the items displayed in the dashboard, wherein the condensed state of the dashboard widget displays in a space mostly everything that is accomplished by a traditional full page view, and wherein the expanded state shows the maximum amount of information regarding the items displayed in the dashboard.

10. The method of claim 1, further comprising:
receiving a drag-and-drop of items, including apparel data, from a plurality of portions of the electronic commerce source.

11. The method of claim 1, further comprising:
providing an animation to indicate a change of state for at least one of site entry, locating a store, opening a container, configuring options for the apparel or widget, locating an item, adding an item, closing the container to show transition from a logical state to another logical state.

12. The method of claim 11, wherein the animation is fading, sliding, expansion, contraction or morphing.

13. A system for shopping for apparel over a network comprising:
a dashboard widget for displaying apparel data; wherein the dashboard widget comprises a plurality of modes for displaying the apparels in the dashboard widget,
a dashboard widget manager configured to perform actions comprising:
providing an activation component within the dashboard widget to configure a panel for providing a selectable catalog of items available in the inventory of an electronic commerce source that are configured to be added into the apparel data; and
in response to adding an item, providing a visual indication of the item on the dashboard widget; wherein the item may then be moved to one of the plurality of modes for displaying the apparels in the dashboard widget.

14. The system of claim 13, wherein the actions further comprise:
providing, over the network, a navigation of the electronic commerce source while simultaneously providing, over the network, the dashboard widget for displaying apparel data at a place on the user's browser, wherein the apparel data is stored in the dashboard widget after the user finishes a shopping session.

15. The system of claim 13, wherein the actions further comprise checking the inventory of the electronic commerce source at the beginning of each shopping session and providing a visual indication regarding the inventory information of each item in the dashboard widget.

16. The system of claim 13, wherein the electronic commerce source comprises a webpage, and wherein the webpage comprises:
a dashboard located in a persistent or attached area of the webpage, wherein the dashboard has at least one tabs for activating each of the plurality of modes for managing the apparels in the dashboard;
wherein the dashboard is in one of the closed state, the condensed state, and the expanded state.

17. The system of claim 16, wherein the plurality of modes for displaying the apparels in the dashboard widget comprises a wish list mode and a purchasing mode;
wherein the wish list mode display items that the user would like to have but choose not to purchase at that time; and
wherein the purchasing mode displays items that the user has decided to purchase at checkout.

18. The system of claim 16, wherein the wish list mode is available to people other than the user through a social network so that they can select one or more items from the wish list mode to purchase for the user.

19. The system of claim 13, wherein the actions further comprise:
providing an animation to indicate a change of state for at least one of site entry, locating a store, opening a container, configuring options for the apparel or widget, locating an item, adding an item, closing the container to show transition from a logical state to another logical state.

20. The system of claim 19, wherein the animation is fading, sliding, expansion, contraction or morphing.

21. A processor readable medium for managing information over a network, the processor readable medium comprising instructions that when executed by a processor cause the processor to perform actions comprising:
providing an interface for managing a user's dashboard widget displaying the apparel data, wherein the dashboard widget comprises at least one mode for displaying the apparels in the dashboard widget; and
checking the inventory of the electronic commerce source at the beginning of each shopping session and providing a visual indication regarding the inventory information of each item in the dashboard widget.

22. The processor readable medium of claim 17, wherein the actions further comprise receiving an item from a plurality of portions of the electronic commerce source.

23. The processor readable medium of claim 17, wherein the actions further comprise
in response to adding an item, providing a visual indication of the item on the dashboard widget.

24. The processor readable medium of claim 17, wherein the actions further comprise
providing at least one qualification component within the dashboard widget for moving an item between the wish list mode and the purchasing mode.

25. The processor readable medium of claim 17, wherein the actions further comprise:
providing an animation to indicate a change of state for at least one of site entry, locating a store, opening a container, configuring options for the apparel or widget, locating an item, adding an item, closing the container to show transition from a logical state to another logical state.

26. The processor readable medium of claim 25, wherein the animation is fading, sliding, expansion, contraction or morphing.

27. A method for processing information, comprising:
providing a dashboard widget, wherein the dashboard widget comprises a plurality of modes of managing shopping items;
activating at least one of the plurality of modes, wherein the modes are configured to manage at least one of the shopping items; and
managing processing of at least one of the shopping items.

28. The method of claim 27, further comprising:
providing notification related to at least one of the items as it relates to at least one of the plurality of modes;
based on the notification, managing moving the shopping items between the plurality of modes.

29. The method of claim 27, further comprising:
providing an animation to indicate a change of state for at least one of site entry, locating a store, opening a container, configuring options for an item or widget, locating the item, adding the item, closing the container to show transition from a logical state to another logical state.

30. The method of claim 29, wherein the animation is fading, sliding, expansion, contraction or morphing.
